(19) United States
(12) Patent Application Publication
(10) Pub. No.: US 2025/0249935 A1
(43) Pub. Date: Aug. 7, 2025

(54) SAFETY RULE GENERATION DEVICE, MOVING BODY, AUTONOMOUS DRIVING SYSTEM, SAFETY RULE GENERATION METHOD, AND PROGRAM

(71) Applicant: INTER-UNIVERSITY RESEARCH INSTITUTE CORPORATION RESEARCH ORGANIZATION OF INFORMATION AND SYSTEMS, Tokyo (JP)

(72) Inventors: Ichiro HASUO, Tokyo (JP); James HAYDON, Tokyo (JP)

(21) Appl. No.: 19/089,867

(22) Filed: Mar. 25, 2025

Related U.S. Application Data
(63) Continuation of application No. PCT/JP2023/034144, filed on Sep. 20, 2023.

(30) Foreign Application Priority Data
Sep. 26, 2022 (JP) 2022-152850

(51) Int. Cl. B60W 60/00; G01C 21/34

(52) U.S. Cl. CPC B60W 60/0015; G01C 21/3461

(57) ABSTRACT

A safety rule generation device includes a memory and a processor coupled to the memory. The memory stores a plurality of general-purpose scenarios for an autonomously-operable moving body to execute a predetermined driving operation, and a plurality of general-purpose safety rules previously calculated so as to complete the general-purpose scenarios while satisfying a predetermined safety condition. The processor receives an input of route information in which a route of travel from a starting position to a target position is divided into a plurality of route segments, assigns the general-purpose scenarios to the respective route segments, and generates an overall safety rule in which the general-purpose safety rules corresponding to the general-purpose scenarios are connected according to an order of the route segments.

### CROSS-REFERENCE TO RELATED APPLICATIONS

This application is a continuation of International Application PCT/JP2023/034144, filed on Sep. 20, 2023 and designated the U.S., which is based on and claims priority to Japanese patent application No. 2022-152850 filed on Sep. 26, 2022, with the Japanese Patent Office. The entire contents of these applications are incorporated herein by reference.

### BACKGROUND OF THE INVENTION

### 1. Field of the Invention

The disclosures herein relate to a safety rule generation device, a moving body, an autonomous driving system, a safety rule generation method, and a program.

### 2. Description of the Related Art

There is a technique for formulating a safety rule for autonomous driving. The safety rule formulation technique is a technique for formulating the safety rule that can be mathematically proven to be safe. For instance, the following Non-Patent Document 1 discloses a mathematical model called Responsibility-Sensitive Safety (RSS).

However, the related-art responsibility-sensitive safety has a problem of not being able to cope with a complex scenario. For instance, Non-Patent Document 1 can only cope with a simple scenario in which an autonomous vehicle avoids a collision with another vehicle travelling in the same lane.

In view of the above technical problem, an object of an aspect of the present invention is to generate a safety rule for safely moving from a starting position to a target position.

Non-Patent Document 1: Shai Shalev-Shwartz, Shaked Shammah, and Amnon Shashua, “On a formal model of safe and scalable self-driving cars,” CoRR, abs/1708.06374, 2017.

### SUMMARY OF THE INVENTION

According to an embodiment, a safety rule generation device comprises: a memory configured to store a plurality of general-purpose scenarios for an autonomously-operable moving body to execute a predetermined driving operation, and a plurality of general-purpose safety rules previously calculated so as to complete the general-purpose scenarios while satisfying a predetermined safety condition; and a processor coupled to the memory and configured to: receive an input of route information in which a route of travel from a starting position to a target position is divided into a plurality of route segments; assign the general-purpose scenarios to the respective route segments; and generate an overall safety rule in which the general-purpose safety rules corresponding to the general-purpose scenarios are connected according to an order of the route segments.

According to at least one embodiment, it is possible to generate the safety rule for safely moving from the starting position to the target position.

### BRIEF DESCRIPTION OF THE DRAWINGS

FIG. 1 is a conceptual diagram illustrating an example of a same-lane same-direction scenario.

FIG. 2 is a conceptual diagram illustrating an example of a road shoulder stop scenario.

FIG. 3 is a conceptual diagram illustrating an example of subscenarios.

FIG. 4 is a diagram illustrating an example of a logical workflow.

FIG. 5 is a block diagram illustrating an example of an overall configuration of an autonomous driving system.

FIG. 6 is a block diagram illustrating an example of a hardware configuration of a computer.

FIG. 7 is a block diagram illustrating an example of a functional configuration of the autonomous driving system.

FIG. 8 is a diagram for describing a parameter of a general-purpose scenario.

FIG. 9 is a conceptual diagram illustrating a first example of the general-purpose scenario.

FIG. 10 is a conceptual diagram illustrating a second example of the general-purpose scenario.

FIG. 11 is a conceptual diagram illustrating a third example of the general-purpose scenario.

FIG. 12 is a flow chart showing an example of a processing procedure of an autonomous driving method.

FIG. 13 is a conceptual diagram illustrating a route according to an embodiment.

### DESCRIPTION OF THE PREFERRED EMBODIMENTS

In the following, an embodiment(s) of the present invention will be described with reference to the accompanying drawings. In the following description and drawings for each embodiment, elements or components having the substantially same or corresponding functional structure or configuration are denoted by the same reference numerals, and their description may be omitted.

Further, the present invention is not limited to the embodiment(s), but various variations and modifications may be made without departing from the scope of the present invention.

### Autonomous Driving Safety Rule Formulation Technique

An autonomous driving safety rule formulation technique is a technique for formulating a safety rule capable of proving mathematically that an autonomous vehicle is “safe as long as the safety rule is satisfied”. For instance, it is a technique of deriving a mathematical formula for determining a safe vehicle distance capable of avoiding a collision of a following autonomous vehicle with a preceding vehicle (a vehicle traveling in front) when the two vehicles are travelling in the same lane and in the same direction.

The autonomous driving safety rule is assumed to be used for the following purposes. A first purpose is to identify the responsibility for an accident (who is responsible for an accident). This is an idea that when an accident occurs, the party who violated the safety rule is guilty of negligence. A second purpose is to prove the safety of the autonomous vehicle. This is an idea that the safety of the autonomous vehicle can be proven by complying with a specific safety rule.

A third purpose is to perform run-time monitoring of the autonomous vehicle. This is to control the autonomous vehicle so as to comply with the safety rule when detecting that the autonomous vehicle is about to violate the safety rule. A fourth purpose is for safety standards or specifications for the autonomous driving. These are regulations that do not permit sales unless the autonomous vehicle complies with the specific safety rule. A fifth purpose is for use in insurance rate calculation. This is to lower an insurance premium for an autonomous vehicle that complies with the specific safety rule, and raise an insurance premium for an autonomous vehicle that does not comply with the specific safety rule.

The autonomous driving safety rule is a concept that is a foundation for social demands for the autonomous driving. If the autonomous vehicle that complies with the safety rule is recognized by the general public as safe and reliable even when travelling on public roads, it is considered that widespread use of the autonomous vehicle is promoted. In addition, the autonomous driving safety rule serves as standards for determining a scope of manufacturer responsibility. This is an idea that when the autonomous vehicle has an accident, as long as the autonomous vehicle complies with the safety rule, the manufacturer is not required to take responsibility.

### Collision Avoiding RSS (CA-RSS)

As a related-art autonomous driving safety rule formulation technique, there is a responsibility-sensitive safety (RSS) disclosed in Non-Patent Document 1. The RSS is widely recognized as the autonomous driving safety rule. For instance, the RSS is used in many academic research, and reflection of the RSS on international standards is being considered.

The related-art RSS is constructed by the following logical structure. That is, the logic is that if a precondition is satisfied, a safety condition can be satisfied by executing a control strategy (proper response). The control strategy is a measure for control of the autonomous vehicle. An example of the control strategy is a driving operation, such as turning a steering wheel, applying brakes, accelerating by depressing an accelerator pedal, etc.

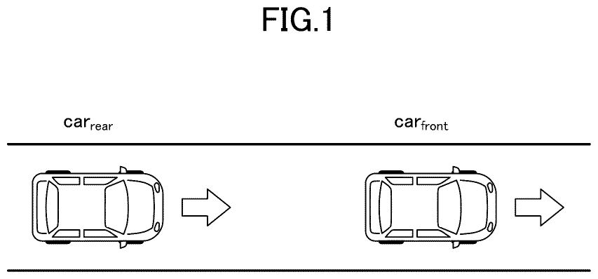

The related-art RSS assumes, for instance, a same-lane same-direction scenario. FIG. 1 is a conceptual diagram illustrating an example of the same-lane same-direction scenario. As illustrated in FIG. 1, the scenario assumes a situation in which two vehicles (Carᵣₑₐᵣ and Car_{front}) are travelling in the same line in the same direction. At least the following vehicle Carᵣₑₐᵣ is an autonomous vehicle, and is subject to the safety rule. The related-art RSS indicates that as long as a vehicle distance determined by a predetermined mathematical formula is maintained, a collision can be avoided by applying an acceleration brake.

However, the related-art RSS only guarantees that the safety condition is satisfied. For instance, in the same-lane same-direction scenario, only a safety condition of the collision avoidance is guaranteed. Hereinafter, the related-art RSS is referred to as “Collision Avoidance RSS (or CA-RSS)”.

### Goal-Aware RSS (GA-RSS)

In the present invention, a safety rule that guarantees that a predetermined postcondition is satisfied in addition to the safety condition is used. Hereinafter, RSS used in the present invention is referred to as “Goal-Aware RSS (or GA-RSS)”.

The goal-aware RSS is constructed by the following logical structure. That is, the logic is that if a precondition is satisfied, the predetermined postcondition can be achieved while satisfying the safety condition, by executing a control strategy.

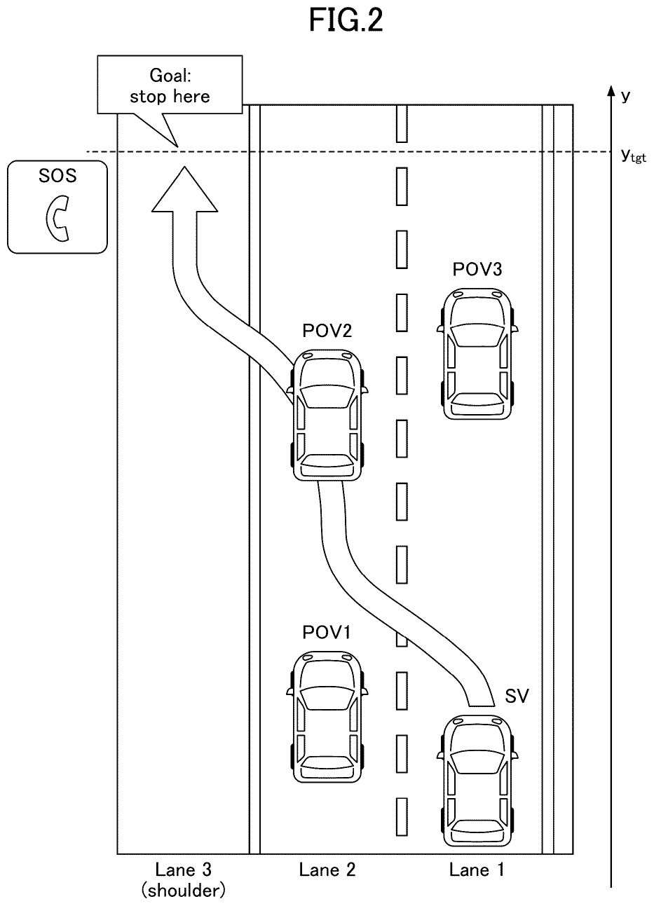

The goal-aware RSS can cope with a scenario that requires a more complex driving operation than the same-lane same-direction scenario. In the following, the goal-aware RSS will be described with a road shoulder stop scenario being an example. FIG. 2 is a conceptual diagram illustrating an example of the road shoulder stop scenario. As illustrated in FIG. 2, in this scenario, in a situation in which a plurality of vehicles are travelling on a road having a plurality of lanes (Lane 1 to 3), the safety condition is that a subject vehicle (SV) maintains safe distances from other vehicles (principal other vehicles) (POVs), and at the same time, the postcondition is that the subject vehicle (SV) changes lanes a plurality of times and safely stops at a position y_{tgt} of an emergency telephone (SOS) installed on a road shoulder (Lane 3).

In such a complex scenario, there are many possible ways to achieve a goal. For instance, when the subject vehicle (SV) changes the lane from a first lane (Lane 1) to a second lane (Lane 2), there is a selection as to whether the subject vehicle (SV) merges in front of or after the other vehicle (POV1) travelling in the second lane (Lane 2). When merging, in order to merge in front of the other vehicle (POV1), there is a selection as to whether the subject vehicle (SV) merges at a current travelling speed or merges by accelerating. Therefore, the precondition that can safely achieve the predetermined postcondition is not obvious.

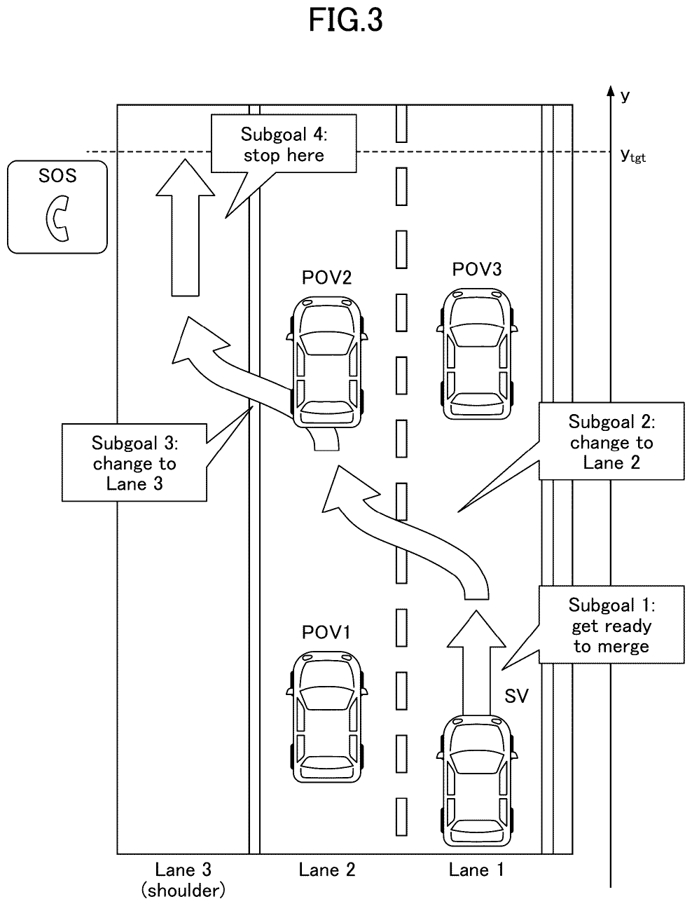

The goal-aware RSS divides the road shoulder stop scenario into a plurality of subscenarios, in order to achieve the predetermined postcondition and the safety condition in the road shoulder stop scenario. FIG. 3 is a conceptual diagram illustrating an example of the subscenarios obtained by dividing the road shoulder stop scenario into the plurality of subscenarios.

As illustrated in FIG. 3, the goal-aware RSS divides the scenario in which the postcondition that the subject vehicle safely stops at the position of the emergency telephone installed on the road shoulder is set, into subgoals 1 to 4. The subgoal 1 is to prepare for the merging. The subgoal 2 is to change the lane to the second lane. The subgoal 3 is to change the lane to the road shoulder. The subgoal 4 is to stop at the position of the emergency telephone.

By achieving these subgoals 1 to 4 in order, the postcondition of the scenario can be achieved. Further, if the control strategy for achieving each of the subgoals 1 to 4 can be executed while constantly satisfying the safety condition, the postcondition can be achieved while satisfying the safety condition.

### Safety Rule Formulation Procedure

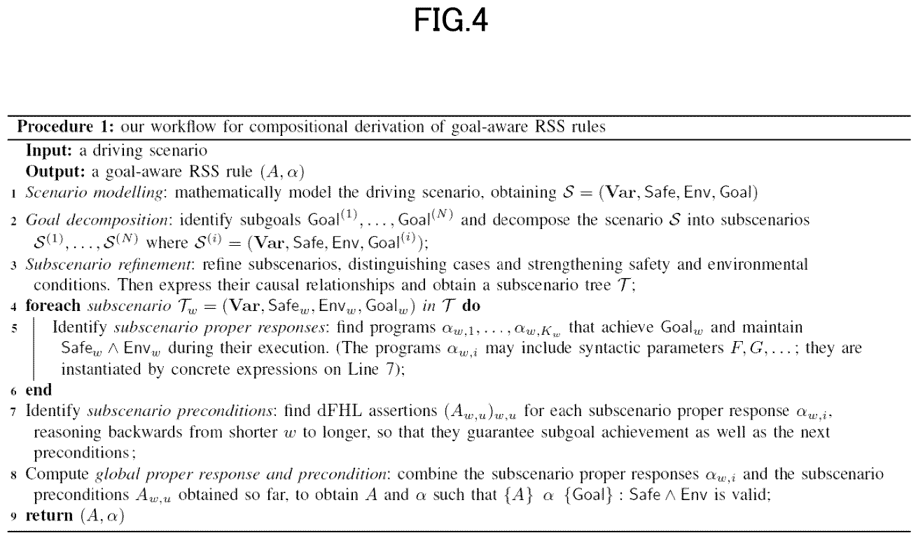

FIG. 4 is a logical workflow for the goal-aware RSS to generate a safety rule. The goal-aware RSS can derive the safety rule that guarantees that the safety condition and the postcondition are satisfied, by a realistic amount of calculation by executing the logical workflow shown in FIG. 4.

However, this logical workflow can be applied to not only the goal-aware RSS, but also, for instance, to the collision avoidance RSS. The present logical workflow is a workflow that derives the safety rule satisfying the safety condition and the postcondition. The collision avoidance RSS only needs to satisfy the safety condition. Therefore, as long as the collision avoidance RSS assumes a complex scenario that can be divided into a plurality of subscenarios, the present logical workflow can be applied to the collision avoidance RSS in the same manner as the goal-aware RSS.

A driving scenario S is input to the workflow of the goal-aware RSS. The workflow of the goal-aware RSS outputs a safety rule (A, α). Here, A represents a set of the preconditions in the driving scenario S. α represents a set of the control strategies in the driving scenario S.

In a first step of the workflow, the driving scenario S is acquired as an input. Here, the driving scenario S includes a safety condition Safe, an environmental condition Env, and a postcondition (goal) Goal.

In a second step of the workflow, N subgoals Goal⁽¹⁾, . . . , Goal^{(N)} are identified from the driving scenario S, and the driving scenario S is divided (decomposed) into N subscenarios S⁽¹⁾, . . . , S^{(N)}.

In a third step of the workflow, a situation of each subscenario S⁽ⁱ⁾ (i=1, . . . , N) is identified, and a safety condition Safe⁽ⁱ⁾ and an environmental condition Env⁽ⁱ⁾ in the identified situation are defined. Then, a scenario tree T=T₁, T₁₁, T₁₂, . . . , T₁₁₁, T₁₂₁, . . . expressing a dependency relationship (a causal relationship) between the subscenarios S⁽¹⁾, . . . , S^{(N)} is generated.

In the subscenario S⁽ⁱ⁾, a plurality of subscenarios T_{w} according to their situations are defined. A subscript i of the subscenario S⁽ⁱ⁾ denotes an order from a beginning of the driving scenario S. A subscript w of the subscenario T^{w} is assigned so that the number of digits increases from an end of the driving scenario S toward the beginning. The dependency relationship of each subscenario T_{w} is expressed by the subscript w of the subscenario T_{w} included in the scenario tree T.

In fourth to sixth steps of the workflow, a control strategy of each subscenario T_{w} is identified. For each subscenario T_{w}, control strategies α_{w,1}, . . . , α_{w,Kw} for achieving the subgoal Goal_{w} while satisfying the safety condition Safe_{w}∧Env_{w} are searched.

For each subscenario T_{w}, one or more control strategies α_{w,k} (k=1, 2, . . . ) are identified. The number of the control strategies α_{w,k} corresponding to each subscenario T_{w} is different. That is, in some subscenarios, one control strategy α_{w,1} is identified, and in other subscenarios, a plurality of control strategies α_{w,k} are identified.

In a seventh step of the workflow, the control strategy α_{w,k} is executed so as to achieve the subgoal Goal_{w}, and a backward inference (a backward reasoning) is performed from w with a small number of digits toward w with a large number of digits so as to satisfy the precondition of the subsequent subscenario. Then, a precondition A_{w,u} of each subscenario T_{w} is identified. Here, the precondition A_{w,u} corresponds to a combination in which one control strategy α_{w,k} is selected for each subscenario T_{w}. A subscript u of the precondition A_{w,u} is an index that identifies the combination of the control strategy α_{w,k}. The subscript u may be, for instance, a value obtained by connecting the subscript k of the control strategy α_{w,k} selected for each subscenario T_{w} according to the dependency relationship of each subscenario T_{w}.

The precondition A_{w,u} of each subscenario T_{w} is calculated in sequence according to the dependency relationship between the subscenarios T_{w}. At this time, the precondition A_{w,u} is calculated so as to satisfy the subgoal Goal_{w} by executing each control strategy α_{w,k} while satisfying the safety condition Safe_{w}∧Env_{w}.

In an eighth step of the workflow, the control strategy α_{w,k} and the precondition A_{w,u} are combined for each subscenario T_{w}. With this combining, the control strategy α and the precondition A of the entire driving scenario S are calculated.

In a ninth step of the workflow, the safety rule (A, α) is output. As mentioned above, A represents a set of the preconditions A_{w,u}in the driving scenario S. α represents a set of the control strategies α_{w,k} in the driving scenario S.

### Embodiments

An autonomous driving system according to an embodiment of the present invention will be described. The autonomous driving system according to the present embodiment is a system that safely moves an autonomously-operable moving body (moving object) from a starting position to a target position. In the autonomous driving system according to the present embodiment, a safety rule generation device generates a safety rule for moving on a route from a starting position to a target position while satisfying a predetermined safety condition. Also, the moving body autonomously executes a driving operation so as to move from the starting position to the target position according to the safety rule.

The safety rule generation device according to the present embodiment pre-stores general-purpose scenarios for the autonomously-operable moving body to perform a predetermined driving operation, and safety rules (hereinafter are also referred to as “general-purpose safety rules”) that satisfy postconditions of the general-purpose scenarios while satisfying the predetermined safety condition.

The general-purpose safety rule is generated so as to logically guarantee that the general-purpose scenario is safely completed. In the present embodiment, the general-purpose safety rule guarantees that the general-purpose scenario is safely completed by the goal-aware RSS. However, the general-purpose safety rule is not limited to a safety rule based on the goal-aware RSS, but could be formed by an arbitrary safety rule.

The safety rule generation device according to the present embodiment divides an entire route into a plurality of routes (hereinafter, a part of divided routes is also referred to as a “route segment”), assigns a general-purpose scenario to each route segment, and connects general-purpose safety rules corresponding to respective general-purpose scenarios according to an order of the route segments. With this, a safety rule (hereinafter is also referred to as an “overall safety rule”) for safely moving on the entire route is generated.

In the present embodiment, each general-purpose safety rule is generated so as to complete the general-purpose scenario while satisfying predetermined safety, by the goal-aware RSS. Therefore, according to the overall safety rule in which the general-purpose safety rules are connected, it is possible to safely complete the entire route even if the route is complicated.

Further, the safety rule generation device according to the present embodiment logically guarantees connectivity of the general-purpose safety rules at connecting points of the general-purpose safety rules in the overall safety rule. With this, the overall safety rule can logically guarantee that the entire route is safely completed even if the route is complicated.

### Overall Configuration of Autonomous Driving System

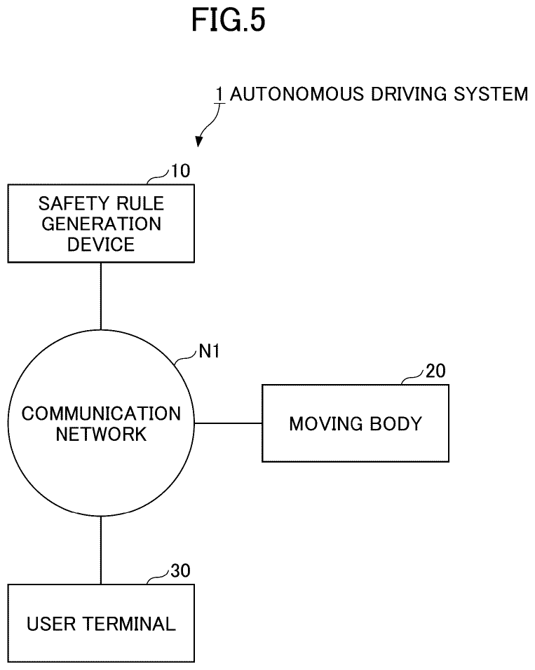

An overall configuration of the autonomous driving system according to the present embodiment will be described with reference to FIG. 5. FIG. 5 is a block diagram illustrating an example of the overall configuration of the autonomous driving system according to the present embodiment.

As illustrated in FIG. 5, an autonomous driving system 1 according to the present embodiment includes a safety rule generation device 10, a moving body (a moving object) 20, and a user terminal 30. The safety rule generation device 10, the moving body 20, and the user terminal 30 are connected to each other so as to be able to carry out data communications via a communication network N1 such as LAN (Local Area network) or the internet.

The safety rule generation device 10 is an information processing device, such as a personal computer, a workstation or a server, which generates a safety rule in response to a request from the user terminal 30. The safety rule generation device 10 receives route information from the user terminal 30. The route information is information that indicates a route for which the safety rule is to be generated. The safety rule generation device 10 generates an overall safety rule based on the route information, and outputs route information with the safety rule. The route information with the safety rule is information that includes the route information and the overall safety rule.

The moving body 20 is a moving body having an autonomous driving function. The moving body 20 pre-stores the route information with the safety rule outputted by the safety rule generation device 10. The moving body 20 autonomously executes a driving operation for moving on the route according to the overall safety rule.

An example of the moving body having the autonomous driving function is an autonomous vehicle. Other examples of the moving body 20 are an unmanned aerial vehicle such as a drone, a route bus whose travel route is fixed, and various robots capable of autonomously travelling such as transfer robots used in manufacturing or logistics sites, etc. The moving body of the present embodiment is not limited to the above vehicle, robots, etc., but can be applied to any moving body that can autonomously operate regardless of whether the moving body is manned or unmanned.

The user terminal 30 is an information processing device, such as a personal computer, a tablet terminal, or a smartphone, which is operated by a user. The user terminal 30 receives an input of the route for which the safety rule is to be generated, in response to user's operation. Then, the user terminal 30 transmits route information in which this input route is divided into a plurality of route segments to the safety rule generation device 10. The user terminal 30 may be incorporated in a vehicle-mounted device mounted in the moving body 20. An example of the vehicle-mounted device is a car navigation system etc.

It is noted that the overall configuration of the autonomous driving system 1 shown in FIG. 5 is an example, and various system configurations could be used according to applications and purposes. For instance, the safety rule generation device 10 could be realized by a plurality of computers, or may be realized as a cloud computing service. Further, for instance, the autonomous driving system 1 could be realized by mounting a vehicle-mounted device having functions which the moving body 20 and the user terminal 30 should each have, in the moving body 20.

### Hardware Configuration of Autonomous Driving System

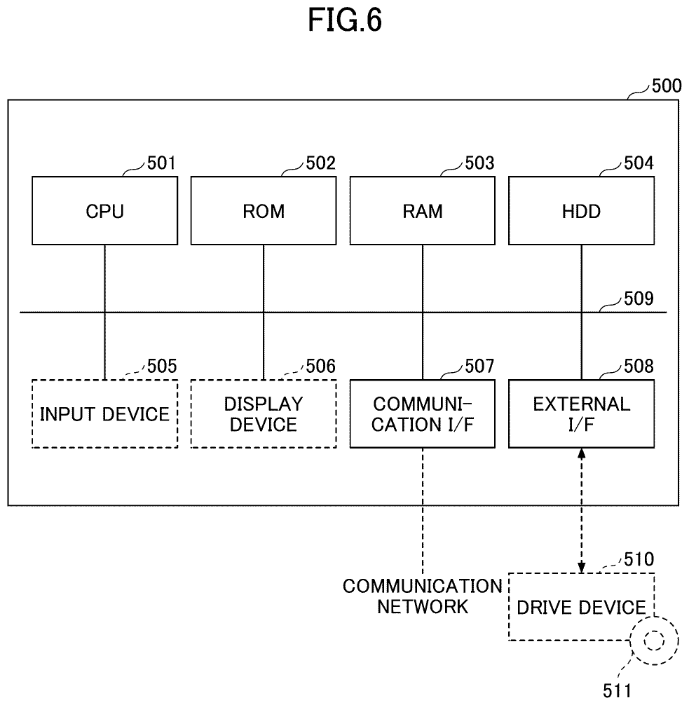

A hardware configuration of each device included in the autonomous driving system 1 according to the present embodiment will be described with reference to FIG. 6.

### Hardware Configuration of Computer

The safety rule generation device 10, the vehicle-mounted device mounted in the moving body 20, and the user terminal 30 in the present embodiment are each realized by, for instance, a computer. FIG. 6 is a block diagram illustrating an example of a hardware configuration of the computer according to the present embodiment.

As illustrated in FIG. 6, a computer 500 according to the present embodiment includes a CPU (Central Processing Unit) 501, a ROM (Read Only Memory) 502, a RAM (Random Access Memory) 503, an HDD (Hard Disk Drive) 504, an input device 505, a display device 506, a communication I/F (Interface) 507, and an external I/F 508. The CPU 501, the ROM 502, and the RAM 503 form a so-called computer. The hardware components in the computer 500 are connected to each other via a bus line 509. Here, the input device 505 and the display device 506 may be used by being connected to the external I/F 508.

The CPU 501 is an arithmetic unit that implements overall control and functions of the computer 500 by reading out a program and data from a storage device (a memory) such as the ROM 502 and the HDD 504 onto the RAM 503 and executing processing.

The ROM 502 is an example of a non-volatile semiconductor memory (a storage device, a memory) that can retain programs and data even when power is turned off. The ROM 502 functions as a main storage device (a memory) that stores various programs, data, etc. required for the CPU 501 to execute various programs installed in the HDD 504. More specifically, the ROM 502 stores boot programs such as BIOS (Basic Input/Output System) and EFI (Extensible Firmware Interface) that are executed when the computer 500 is started, and data such as OS (Operating System) settings and network settings.

The RAM 503 is an example of a volatile semiconductor memory (a storage device, a memory) in which programs and data are erased when power is turned off. The RAM 503 is, for instance, a DRAM (Dynamic Random Access Memory) or an SRAM (Static Random Access Memory). The RAM 503 provides a working area in which various programs installed in the HDD 504 are expanded when being executed by the CPU 501.

The HDD 504 is an example of a non-volatile storage device (a memory) that stores programs and data. The programs and data stored in the HDD 504 are, for instance, an OS which is basic software that controls the entire computer 500, and applications that provide various functions on the OS. It is noted that the computer 500 may use, instead of the HDD 504, a storage device (e.g. an SSD: Solid State Drive) using a flash memory as a storage medium.

The input device 505 is, for instance, a touch panel, operation keys or buttons, a keyboard or a mouse which are used by the user to input various signals, and a microphone for inputting sound data such as voice.

The display device 506 is configured by a display such as a liquid crystal display or an organic EL (Electro-Luminescence) display for displaying a screen, a speaker for outputting sound data such as voice, etc.

The communication I/F 507 is an interface that is connected to a communication network and enables the computer 500 to perform data communication.

The external I/F 508 is an interface with an external device. The external device is, for instance, a drive device 510.

The drive device 510 is a device for inserting a recording medium 511 therein. The recording medium 511 here includes media that record information optically, electrically or magnetically, such as CD-ROMs, flexible disks, and magneto-optical disks. Further, the recording medium 511 may include a semiconductor memory, such as a ROM or a flash memory, which electrically records information. This allows the computer 500 to read and/or write data from and to the recording medium 511 via the external I/F 508.

Here, the various programs to be installed in the HDD 504 are installed, for example, by setting the distributed recording medium 511 in the drive device 510 connected to the external I/F 508 and also reading out, by the drive device 510, the various programs recorded in the recording medium 511. Alternatively, the various programs to be installed in the HDD 504 may be installed by being downloaded from another network that is different from the communication network via the communication I/F 507.

### Functional Configuration of Autonomous Driving System

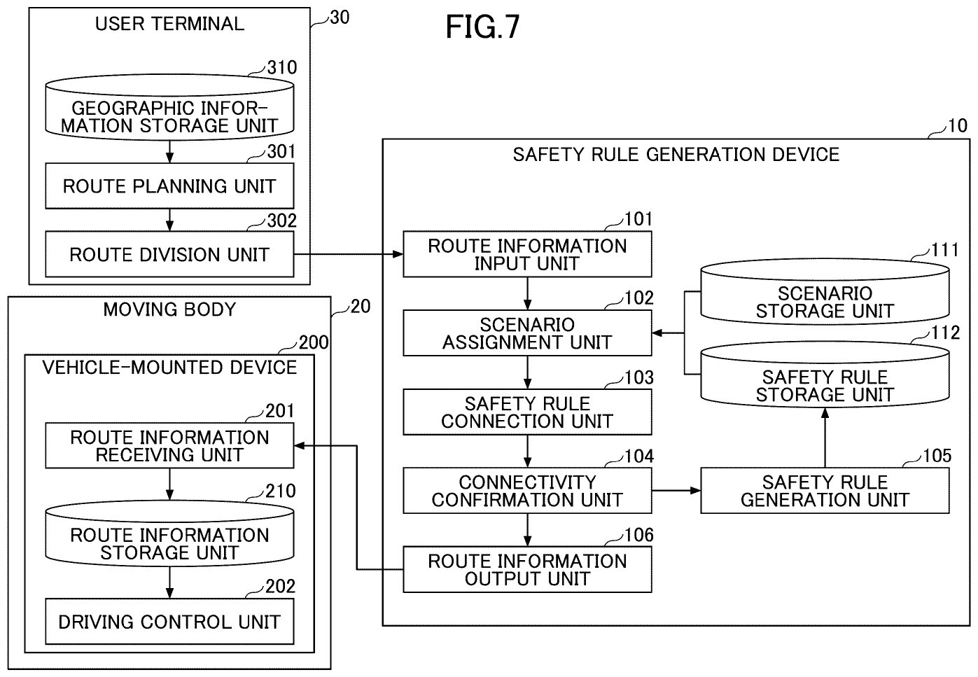

A functional configuration of the autonomous driving system according to the present embodiment will be described with reference to FIG. 7. FIG. 7 is a block diagram illustrating an example of the functional configuration of the autonomous driving system 1 according to the present embodiment.

### Functional Configuration of User Terminal

As illustrated in FIG. 7, the user terminal 30 according to the present embodiment has a route planning unit 301, a route division unit 302, and a geographic information storage unit (a memory) 310.

The route planning unit 301 and the route division unit 302 are realized, for instance, by processing of a program developed on the RAM 503 from the HDD 504 illustrated in FIG. 6 which is executed by the CPU 501. The geographic information storage unit 310 is realized, for instance, using the HDD 504 illustrated in FIG. 6.

The geographic information storage unit 310 stores geographic information. The geographic information includes map information showing a map of an area in which the moving body 20 can move, route information showing a route on which the moving body 20 can travel between arbitrary two points on the map, and congestion information showing a congestion state of each route, etc. The geographic information may be updated at any time using a communication means connected to a mobile communication network or the like.

The geographic information stored in the geographic information storage unit 310 differs depending on a type of the moving body 20. If the moving body 20 is, for instance, the autonomous vehicle, the geographic information includes two-dimensional map information showing layout or arrangement of buildings and roads, road information showing roads on which the autonomous vehicle can travel, congestion information of each road, etc. Further, if the moving body 20 is, for instance, the unmanned aerial vehicle, the geographic information includes an airspace map showing an airspace in which the unmanned aerial vehicle can fly, air-traffic control information showing unmanned aerial vehicles currently flying in each airspace, etc.

The route planning unit 301 receives an input of a starting position and a target position in response to user's operation. The route planning unit 301 plans a route from the starting position to the target position based on the geographic information read out from the geographic information storage unit 310.

The route division unit 302 divides the route planned by the route planning unit 301 into a plurality of route segments. The route division unit 302 may divide the route based on type, number, etc. of the driving operation executed in each route segment. Also, the route division unit 302 may divide the route according to user's operation, or may divide the route according to a predetermined division rule. The route division unit 302 transmits route information including a plurality of route segments to the safety rule generation device 10.

### Functional Configuration of Safety Rule Generation Device

As illustrated in FIG. 7, the safety rule generation device 10 according to the present embodiment has a route information input unit 101, a scenario assignment unit 102, a safety rule connection unit 103, a connectivity confirmation unit 104, a safety rule generation unit 105, a route information output unit 106, a scenario storage unit (a memory) 111, and a safety rule storage unit (a memory) 112.

The route information input unit 101, the scenario assignment unit 102, the safety rule connection unit 103, the connectivity confirmation unit 104, the safety rule generation unit 105, and the route information output unit 106 are realized, for instance, by processing of a program developed on the RAM 503 from the HDD 504 illustrated in FIG. 6 which is executed by the CPU 501. The scenario storage unit 111 and the safety rule storage unit 112 are realized, for instance, using the HDD 504 illustrated in FIG. 6.

The scenario storage unit 111 pre-stores a plurality of general-purpose scenarios. The general-purpose scenario is a driving scenario for the moving body 20 to autonomously or automatically perform a pre-defined driving operation. The driving scenario defined as the general-purpose scenario may be a series of driving operations that are considered to often occur in an actual driving environment.

The general-purpose scenario may include one or more parameters. The parameter of the general-purpose scenario is an attribute that defines a driving environment in which a predetermined driving operation is performed. The general-purpose scenario can be said to be versatile in that the parameters are undetermined. By specifically setting the parameters of the general-purpose scenario, it becomes possible to assign the same general-purpose scenario to a plurality of route segments that execute the same type of driving operation.

In the general-purpose scenario, a precondition and a postcondition are defined. The postcondition of the general-purpose scenario may be a condition that can be technically feasible and that can be socially acceptable. Each general-purpose scenario is associated with a general-purpose safety rule. In the present embodiment, the general-purpose safety rule is previously generated based on the goal-aware RSS so as to satisfy the postcondition of the general-purpose scenario while satisfying the predetermined safety condition.

The general-purpose scenario may be a scenario tree in which a plurality of subscenarios are linked. The subscenario is information for associating a control strategy with a purpose (a goal). The purpose (the goal) of the subscenario includes the safety condition and the postcondition. The postcondition of the subscenario is information indicating the subgoal of the subscenario. The postcondition of the general-purpose scenario corresponds to the postcondition of the last subscenario.

### General-Purpose Scenario

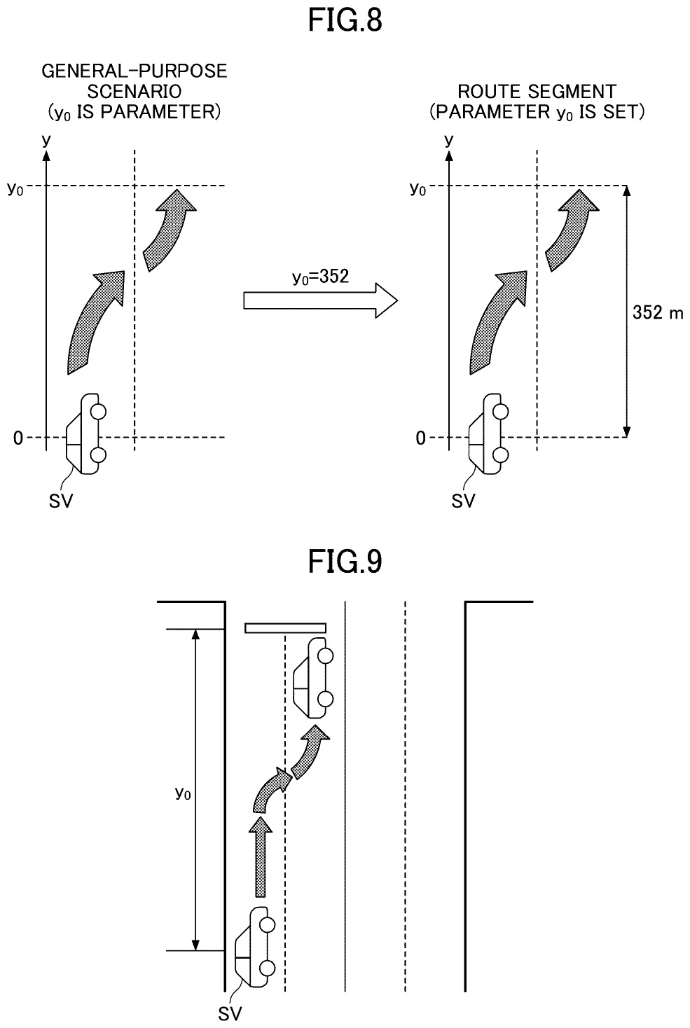

The general-purpose scenario according to the present embodiment will be described with reference to FIGS. 8 to 11.

FIG. 8 is a diagram for describing an example of the parameter of the general-purpose scenario. FIG. 8 illustrates a general-purpose scenario in which an autonomous vehicle SV traveling on a straight road with two lanes in each direction changes the lane to a right lane and stops at a target stopping position. In this general-purpose scenario, a parameter y₀ indicating a distance from a current position to the stopping position is set.

Here, it is assumed that a distance from the current position to the stopping position in the route segment is 352 meters. Then, a specific scenario in which yo₀=352 is set in the general-purpose scenario is generated. In this manner, the general-purpose scenario can be applied to the route segment that represents the actual driving environment.

FIG. 9 is a conceptual diagram illustrating a first example of the general-purpose scenario. The first example of the general-purpose scenario is a scenario in which the autonomous vehicle SV traveling in a left lane on a straight road with two lanes in each direction changes the lane to a right lane and stops at a stop line at an intersection. A postcondition of this general-purpose scenario is defined as, for instance, “the autonomous vehicle changes the lane to the right lane and temporarily stops”.

In the general-purpose scenario shown in FIG. 9, a parameter y₀ indicating a distance from a current position of the autonomous vehicle SV to the stop line is set. Therefore, if a route segment is a route segment in which the autonomous vehicle SV changes the lane from the left lane to the right lane and temporarily stops, even if the distance from the current position to the stopping position is different, this general-purpose scenario can be applied.

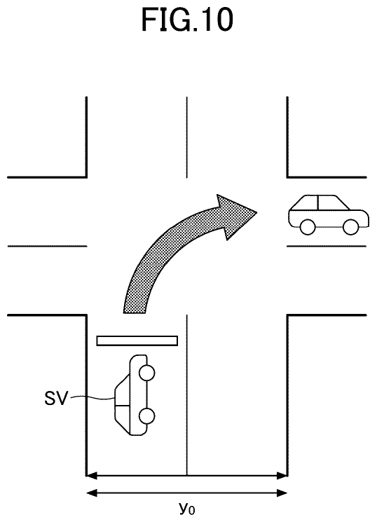

FIG. 10 is a conceptual diagram illustrating a second example of the general-purpose scenario. The second example of the general-purpose scenario is a scenario in which the autonomous vehicle SV having entered the intersection turns right. A postcondition of this general-purpose scenario is defined as, for instance, “the autonomous vehicle has passed through the intersection and a speed after passing through the intersection is equal to or lower than the legal speed limit”.

In the general-purpose scenario shown in FIG. 10, a parameter y₀ indicating a width of the road where the autonomous vehicle SV enters the intersection is set. Therefore, if a route segment is a route segment in which the autonomous vehicle SV turns right at the intersection, even if the width of the road is different, this general-purpose scenario can be applied.

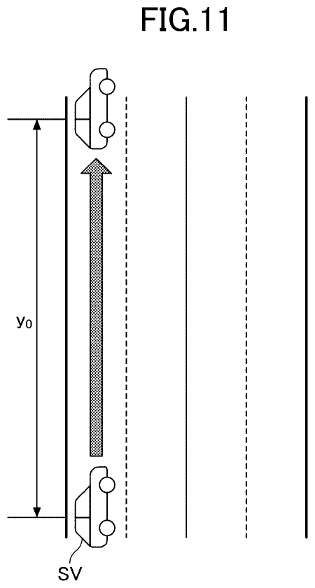

FIG. 11 is a conceptual diagram illustrating a third example of the general-purpose scenario. In the third example of the general-purpose scenario, the autonomous vehicle SV traveling in a left lane on a straight road with two lanes in each direction stops on a road shoulder. A postcondition of this general-purpose scenario is defined as, for instance, “the autonomous vehicle travels straight in the left lane and stops on the road shoulder”.

In the general-purpose scenario shown in FIG. 11, a parameter y₀ indicating a distance from a current position of the autonomous vehicle SV to a target stopping position is set. Therefore, if a route segment is a route segment in which the autonomous vehicle SV travels in the left lane and stops on the road shoulder, even if the distance from the current position to the stopping position is different, this general-purpose scenario can be applied.

Returning to FIG. 7, the description will be provided. The safety rule storage unit 112 pre-stores the general-purpose safety rules corresponding to the respective general-purpose scenarios stored in the scenario storage unit 111. The general-purpose safety rule is a safety rule that satisfies the postcondition of the general-purpose scenario while satisfying the predetermined safety condition. The general-purpose safety rule can be generated according to the logical workflow shown in FIG. 4.

The general-purpose safety rule may be information in which the precondition and the control strategy for each subscenario are combined. The precondition may be calculated so as to execute the control strategy while achieving the purpose (the goal), for each subscenario. A precondition of a certain subscenario may be calculated so as to satisfy a postcondition of this subscenario and satisfy a precondition of the subsequent subscenario, by executing the control strategy while satisfying the safety condition. The precondition may be sequentially calculated by tracing back the link of the subscenarios by incremental backpropagation.

The route information input unit 101 receives an input of the route information. The route information is information in which the route of the travelling from the starting position to the target position is divided into a plurality of route segments. The route information input unit 101 may receive the route information by receiving the route information from the user terminal 30. The route information input unit 101 may receive the route information from the input device 505 etc. in response to user's operation.

The scenario assignment unit 102 assigns one of the general-purpose scenarios read out from the scenario storage unit 111 to each route segment included in the route information received by the route information input unit 101. The scenario assignment unit 102 may assign the general-purpose scenario capable of realizing a driving operation executed in the route segment to this route segment.

The safety rule connection unit 103 connects the general-purpose safety rules corresponding to the general-purpose scenarios assigned to the respective route segments, according to an order of the route segments included in the route information. With this, an overall safety rule for safely moving on the entire route is generated. The safety rule connection unit 103 may arrange the general-purpose safety rules according to the order of the route segments, and generate the safety rule by combining these general-purpose safety rules. The connectivity confirmation unit 104 confirms that the general-purpose safety rules can be connected.

The connectivity confirmation unit 104 confirms the connectivity of the general-purpose safety rules in the overall safety rule. The connectivity confirmation unit 104 logically proves that at a connecting point of the general-purpose safety rules in the overall safety rule, a postcondition of the general-purpose scenario corresponding to a preceding general-purpose safety rule satisfies a precondition of the general-purpose scenario corresponding to the following general-purpose safety rule. If the connectivity confirmation unit 104 can logically prove that the postcondition of the preceding general-purpose scenario satisfies the precondition of the following general-purpose scenario, the connectivity between the preceding general-purpose safety rule and the following general-purpose safety rule can be confirmed.

The safety rule generation unit 105 generates a new safety rule that is different from the general-purpose safety rules stored in the safety rule storage unit 112. The safety rule generation unit 105 generates the new safety rule when there is a route segment to which a general-purpose scenario has not been assigned by the scenario assignment unit 102, or when the connectivity of the general-purpose safety rules in the overall safety rule has not been able to be confirmed by the connectivity confirmation unit 104.

When the route segment to which the general-purpose scenario has not been assigned by the scenario assignment unit 102 is present, the safety rule generation unit 105 defines a new scenario corresponding to this route segment and generates a new safety rule corresponding to the new scenario. The safety rule generation unit 105 may generate a new safety rule based on the goal-aware RSS. When the connectivity of the general-purpose safety rules in the overall safety rule has not been able to be confirmed by the connectivity confirmation unit 104, the safety rule generation unit 105 generates a new safety rule by updating one of the general-purpose safety rules at a connecting point where the connectivity has not been able to be confirmed.

The safety rule generation unit 105 may generate a safety rule in which the postcondition of the general-purpose scenario corresponding to the preceding general-purpose safety rule is strengthened, at the connecting point of the general-purpose safety rules where the connectivity has not been able to be confirmed by the connectivity confirmation unit 104. The safety rule generation unit 105 may generate a safety rule in which the precondition of the general-purpose scenario corresponding to the following general-purpose safety rule is relaxed, at the connecting point of the general-purpose safety rules where the connectivity has not been able to be confirmed by the connectivity confirmation unit 104.

The route information output unit 106 outputs route information with the safety rule. The route information with the safety rule includes the route information input to the route information input unit 101 and the overall safety rule in which the connectivity has been able to be confirmed by the connectivity confirmation unit 104.

The route information output unit 106 may output the route information by transmitting the route information with the safety rule to the moving body 20. The route information output unit 106 may output the route information by transmitting the route information with the safety rule to the user terminal 30.

### Functional Configuration of Moving Body

As illustrated in FIG. 7, the moving body 20 according to the present embodiment has a vehicle-mounted device 200. The vehicle-mounted device 200 according to the present embodiment has a route information receiving unit 201, a driving control unit 202, and a route information storage unit (a memory) 210.

The route information receiving unit 201 and the driving control unit 202 are realized, for instance, by processing of a program developed on the RAM 503 from the HDD 504 illustrated in FIG. 6 which is executed by the CPU 501. The route information storage unit 210 is realized, for instance, using the HDD 504 illustrated in FIG. 6.

The route information storage unit 210 stores the route information with the safety rule. The route information with the safety rule includes the route information generated by the user terminal 30 and the overall safety rule generated by the safety rule generation device 10.

The route information receiving unit 201 receives an input of the route information with the safety rule. The route information receiving unit 201 stores the received route information with the safety rule in the route information storage unit 210. The route information receiving unit 201 may receive the route information with the safety rule by receiving the route information with the safety rule from the safety rule generation device 10. The route information receiving unit 201 may receive the route information with the safety rule from the input device 505 etc. in response to user's operation.

The driving control unit 202 executes a driving operation based on the route information with the safety rule read out from the route information storage unit 210. The driving control unit 202 executes the driving operation so as to move on the route from the starting position to the target position according to the overall safety rule included in the route information with the safety rule. Accordingly, autonomous driving allowing the moving body 20 to move from the starting position to the target position while satisfying the predetermined safety condition is realized.

### Processing Procedure of Autonomous Driving System

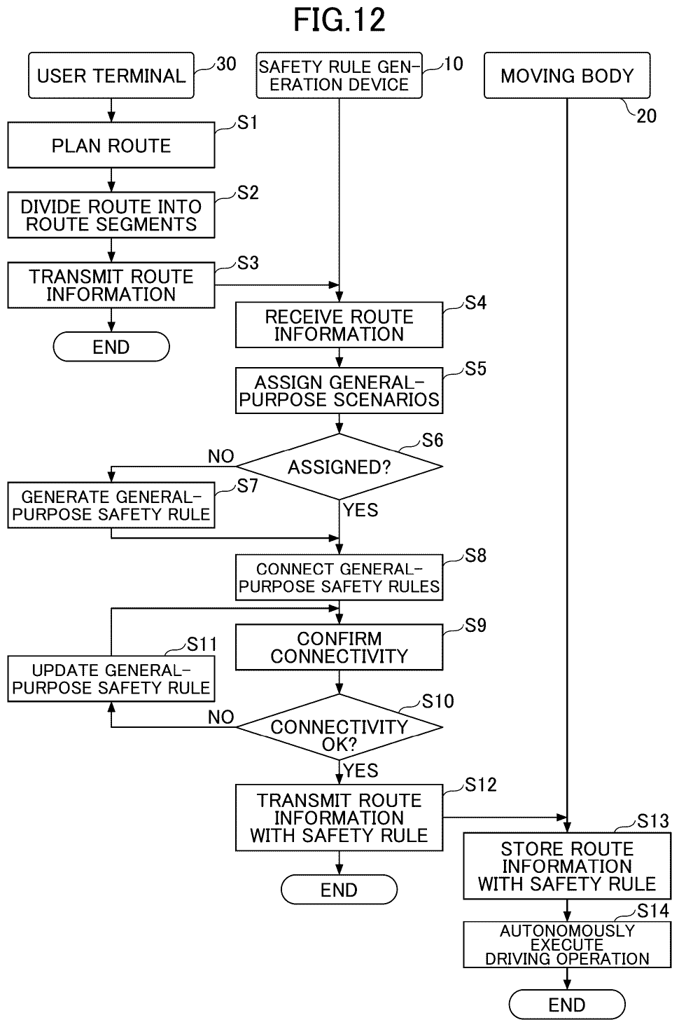

A processing procedure of an autonomous driving method executed by the autonomous driving system 1 according to the present embodiment will be described with reference to FIG. 12. FIG. 12 is a flow chart showing an example of the processing procedure of the autonomous driving method.

In step S1, the route planning unit 301 included in the user terminal 30 receives an input of a starting position and a target position in response to user's operation. The starting position and the target position may be set in advance and stored in a storage device such as the HDD 504. The starting position may be a current position identified by a GPS (Global Positioning System) function etc. installed in the user terminal 30.

Next, the route planning unit 301 reads out geographic information from the geographic information storage unit 310. Subsequently, the route planning unit 301 plans a route from the starting position to the target position based on the geographic information. Then, the route planning unit 301 transmits information indicating the generated route to the route division unit 302.

In step S2, the route division unit 302 included in the user terminal 30 receives the information indicating the route from the route planning unit 301. Next, the route division unit 302 divides the route into route segments in response to the user's operation. The route division unit 302 may divide the route into route segments according to a predetermined division rule stored the storage device.

In step S3, the route division unit 302 included in the user terminal 30 generates route information including the plurality of route segments. Subsequently, the route division unit 302 transmits the generated route information to the safety rule generation device 10.

In step S4, the route information input unit 101 included in the safety rule generation device 10 receives the route information from the user terminal 30. Next, the route information input unit 101 receives an input of the received route information. Subsequently, the route information input unit 101 transmits the received route information to the scenario assignment unit 102.

In step S5, the scenario assignment unit 102 included in the safety rule generation device 10 receives the route information from the route information input unit 101. Next, the scenario assignment unit 102 reads out general-purpose scenarios from the scenario storage unit 111. Subsequently, the scenario assignment unit 102 assigns the general-purpose scenarios to the respective route segments included in the route information.

In step S6, the scenario assignment unit 102 included in the safety rule generation device 10 determines whether or not the general-purpose scenario has been assigned to all the route segments. If the general-purpose scenario has been assigned to all the route segments (i.e. YES), the routine proceeds to step S8 by the scenario assignment unit 102. On the other hand, if there is a route segment to which the general-purpose scenario has not been assigned (i.e. NO), the scenario assignment unit 102 transmits the route information to the safety rule generation unit 105, and the routine proceeds to step S7.

In step S7, the safety rule generation unit 105 included in the safety rule generation device 10 receives the route information from the scenario assignment unit 102. Next, the safety rule generation unit 105 identifies the route segment to which the general-purpose scenario has not been assigned from the received route information.

Subsequently, the safety rule generation unit 105 generates a new general-purpose scenario corresponding to the identified route segment. Then, the safety rule generation unit 105 generates a new general-purpose safety rule corresponding to the generated general-purpose scenario. Next, the safety rule generation unit 105 assigns the generated new general-purpose scenario to the route segment. The safety rule generation unit 105 transmits the route information including the route segment to which the new general-purpose scenario is assigned to the safety rule connection unit 103.

Further, the safety rule generation unit 105 stores the generated new general-purpose scenario in the scenario storage unit 111. Also, the safety rule generation unit 105 stores the generated new general-purpose safety rule in the safety rule storage unit 112. This makes it possible to assign the new general-purpose scenario to the same type of route segment.

In step S8, the safety rule connection unit 103 included in the safety rule generation device 10 receives the route information from the scenario assignment unit 102 or the safety rule generation unit 105. In the route information, the general-purpose scenario has been assigned to all the route segments.

Next, the safety rule connection unit 103 reads out general-purpose safety rules corresponding to the general-purpose scenarios assigned to the route segments included in the route information, from the safety rule storage unit 112. Subsequently, the safety rule connection unit 103 connects the read general-purpose safety rules according to an order of the route segments included in the route information. Then the safety rule connection unit 103 transmits an overall safety rule in which the general-purpose safety rules are connected, to the connectivity confirmation unit 104.

In step S9, the connectivity confirmation unit 104 included in the safety rule generation device 10 receives the overall safety rule from the safety rule connection unit 103. Next, the connectivity confirmation unit 104 confirms the connectivity of the general-purpose safety rules in the overall safety rule. More specifically, the connectivity confirmation unit 104 logically proves that at a connecting point of the general-purpose safety rules in the overall safety rule, a postcondition of the general-purpose scenario corresponding to a preceding general-purpose safety rule satisfies a precondition of the general-purpose scenario corresponding to the following general-purpose safety rule.

A method of confirming the connectivity will now be described in more detail. In the following, Rt represents the entire route. Rt₁, . . . , Rtₙ represent the respective route segments obtained by dividing the route Rt. S₁, . . . , Sₙ represent the general-purpose scenarios assigned to the route segments Rt₁, Rtₙ respectively. Rl₁, . . . , Rlₙ represent the general-purpose safety rules associated with the general-purpose scenarios S₁, . . . , Sₙ respectively.

For the general-purpose scenarios S₁, . . . , Sₙ, postconditions PtC₁, . . . , PtCₙ, in which respective parameters y₀ are set, and preconditions PrC₁, . . . , PrCₙ, in which respective parameters y₀ are set, are set. First, numerical values determined by the route segments Rt₁, . . . , Rtₙ are substituted into the respective parameters y₀ of the postconditions PtC₁, . . . , PtCₙ and the preconditions PrC₁, . . . , PrCₙ. With this substitution, specific (i.e. parameter-free) postconditions PtC′₁, . . . , PtC′ₙ and specific (i.e. parameter-free) preconditions PrC′₁, . . . , PrC′ₙ can be obtained.

The parameter y₀ is, for instance, a distance to the next intersection. The precondition with the parameter is expressed as v*v−a*y₀/2≤0, etc.

When specific route segments Rtᵢ (i=1, . . . , n) are determined, numerical values of the parameters y₀ to be set to the postconditions PtCᵢ and the preconditions PrCᵢ are determined. For instance, when the distance to the next intersection is 300 meters, “y₀=300” is set.

The connectivity between the preconditions and the postconditions is confirmed by mathematically proving that “PrC→PrC′₁, PtC′ᵢ→PrC′ᵢ₊₁ (i=1, 2, . . . , n-1), PtC′ₙ→PtC” are satisfied. Here, “→” is an operator representing a logical “if”. “PrC” and “PtC” are the precondition and the postcondition of the route Rt.

In step S10, the connectivity confirmation unit 104 included in the safety rule generation device 10 determines whether or not the connectivity has been confirmed at all connecting points of the general-purpose safety rules in the overall safety rule. If the connectivity is confirmed at all the connecting points of the general-purpose safety rules (i.e. YES), the connectivity confirmation unit 104 transmits the overall safety rule to the route information output unit 106, and the routine proceeds to step S12. On the other hand, if there is a connecting point where the connectivity has not been able to be confirmed (i.e. NO), the connectivity confirmation unit 104 transmits information indicating the connecting point where the connectivity has not been able to be confirmed to the safety rule generation unit 105, and the routine proceeds to step S11.

In step S11, the safety rule generation unit 105 included in the safety rule generation device 10 receives the information indicating the connecting point where the connectivity has not been able to be confirmed from the connectivity confirmation unit 104. Next, the safety rule generation unit 105 updates the preceding general-purpose safety rule or the following general-purpose safety rule at the connecting point of the general-purpose safety rules where the connectivity has not been able to be confirmed.

In a case where the preceding general-purpose safety rule is updated, the safety rule generation unit 105 generates a safety rule in which the postcondition of the general-purpose scenario corresponding to the preceding general-purpose safety rule is strengthened. In a case where the following general-purpose safety rule is updated, the safety rule generation unit 105 generates a safety rule in which the precondition of the general-purpose scenario corresponding to the following general-purpose safety rule is relaxed.

Subsequently, the safety rule generation unit 105 transmits the overall safety rule, in which the general-purpose safety rule is updated at the connecting point where the connectivity has not been able to be confirmed, to the connectivity confirmation unit 104, and the routine is returned to step S9. Until the connectivity is confirmed at all the connecting points, processing from step S8 to step S11 is repeatedly executed.

In step S12, the route information output unit 106 included in the safety rule generation device 10 receives the overall safety rule from the connectivity confirmation unit 104. This overall safety rule is an overall safety rule in which the connectivity has been confirmed at all the connecting points of the general-purpose safety rules. Next, the route information output unit 106 includes the received overall safety rule into the route information received by the route information input unit 101. With this, a route information with the safety rule is generated. Subsequently, the route information output unit 106 transmits the generated route information with the safety rule to the moving body 20.

In step S13, the route information receiving unit 201 included in the moving body 20 receives the route information with the safety rule from the safety rule generation device 10. Next, the route information receiving unit 201 receives an input of the received route information with the safety rule. Subsequently, the route information receiving unit 201 stores the received route information with the safety rule in the route information storage unit 210.

In step S14, the driving control unit 202 included in the moving body 20 reads out the route information with the safety rule from the route information storage unit 210. Next, the driving control unit 202 executes a driving operation based on the read route information with the safety rule. More specifically, the driving control unit 202 autonomously executes the driving operation so as to move on the route from the starting position to the target position according to the overall safety rule included in the route information with the safety rule.

### Embodiment

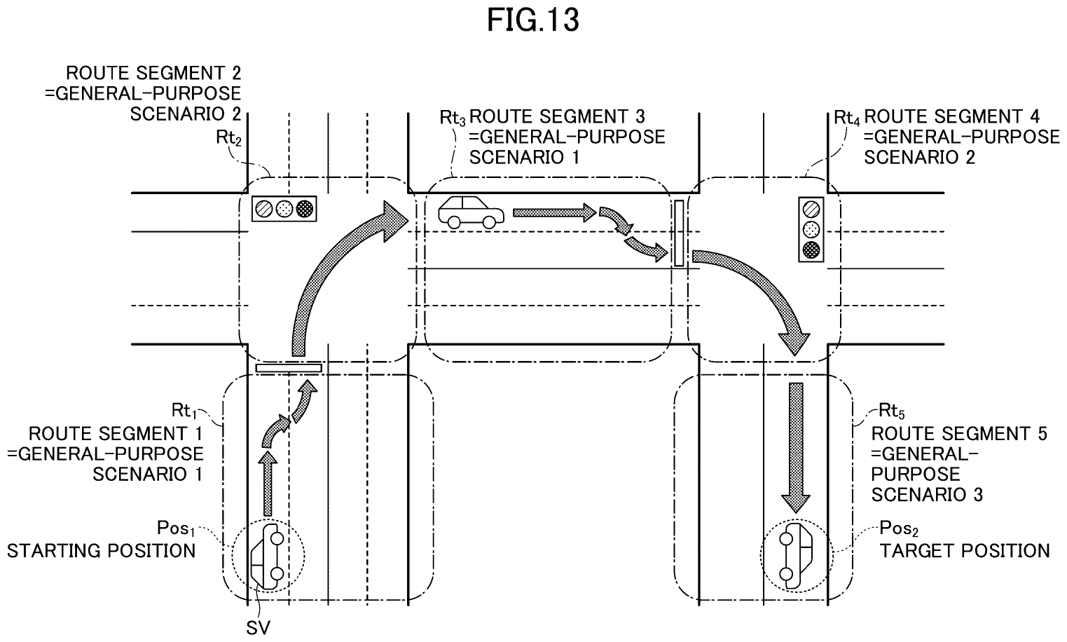

An embodiment in which the safety rule of the entire route is generated by the autonomous driving system according to the present embodiment will be described with reference to FIG. 13. FIG. 13 is a conceptual diagram illustrating an example of the route information according to the present embodiment.

As illustrated in FIG. 13, in the present embodiment, a route on which an autonomous vehicle SV travels from a starting position Pos₁ to a target position Pos₂ is a route for which the safety rule is to be generated. First, the autonomous vehicle SV travels straight from the starting position Pos₁ toward an upper direction of FIG. 13, and changes the lane to a right lane in order to turn right at a first intersection. Next, the autonomous vehicle SV turns right at the first intersection, and enters a left lane. Subsequently, the autonomous vehicle SV travels straight from the first intersection toward a right direction of FIG. 13, and changes the lane to a right lane in order to turn right at a second intersection. Then, the autonomous vehicle SV turns right at the second intersection. Afterwards, the autonomous vehicle SV travels straight from the second intersection toward a lower direction of FIG. 13, and stops at the target position Pos₂.

First, the general-purpose scenarios are defined, and the safety rules (i.e. general-purpose safety rules) of the goal-aware RSS corresponding to the respective general-purpose scenarios are generated. In the present embodiment, at least two general-purpose scenarios are prepared. The generation of the general-purpose safety rules can be performed according to the logical workflow shown in FIG. 4.

A first general-purpose scenario (a general-purpose scenario 1) is a scenario in which the autonomous vehicle SV travels on the left lane, and identifies a red light at the intersection with traffic lights after changing the lane to the right lane, then temporarily stops. A second general-purpose scenario (a general-purpose scenario 2) is a scenario in which the autonomous vehicle SV identifies a green light of the traffic lights, and turns right at the intersection after checking that no oncoming vehicles are approaching, then enters the left lane.

A general-purpose safety rule (a general-purpose safety rule 1) corresponding to the general-purpose scenario 1 is generated as follows. In the general-purpose scenario 1, in a situation in which a plurality of vehicles are travelling on a road having a plurality of lanes, a safety condition is that the autonomous vehicle SV maintains safe distances from other vehicles POVs, and at the same time, a postcondition is that the autonomous vehicle SV changes the lane to the right lane and safely temporarily stops at the stop line at the intersection.

In order to achieve the above safety condition and postcondition in the general-purpose scenario 1, the goal-aware RSS divides the scenario in which the postcondition that the autonomous vehicle safely temporarily stops at the stop line is set, into subgoals 11 to 13. The subgoal 11 is to prepare for the lane change. The subgoal 12 is to change the lane to the right lane. The subgoal 13 is to temporarily stop at the stop line at the intersection.

By achieving these subgoals 11 to 13 in order, the postcondition of the general-purpose scenario 1 can be achieved. Further, if the control strategy for achieving each of the subgoals 11 to 13 can be executed while constantly satisfying the safety condition, the postcondition can be achieved while satisfying the safety condition.

A general-purpose safety rule (a general-purpose safety rule 2) corresponding to the general-purpose scenario 2 is generated as follows. In the general-purpose scenario 2, in a situation in which a plurality of vehicles are travelling on a road having a plurality of lanes, a safety condition is that the autonomous vehicle SV maintains safe distances from other vehicles POVs, and at the same time, a postcondition is that the autonomous vehicle SV checks that no oncoming vehicles are approaching after checking the traffic lights at a position of the stop line at the intersection, turns right, and enters the left lane.

In order to achieve the above safety condition and postcondition in the general-purpose scenario 2, the goal-aware RSS divides the scenario in which the postcondition that the autonomous vehicle turns right and enters the left lane is set, into subgoals 21 to 23. The subgoal 21 is to check the traffic lights at the position of the stop line and to prepare for the right-turn. The subgoal 22 is to check that no oncoming vehicles are approaching, to start moving, and to turn right. The subgoal 23 is to enter the left lane after turning right.

By achieving these subgoals 21 to 23 in order, the postcondition of the general-purpose scenario 2 can be achieved. Further, if the control strategy for achieving each of the subgoals 21 to 23 can be executed while constantly satisfying the safety condition, the postcondition can be achieved while satisfying the safety condition.

Next, the route is divided into route segments. As illustrated in FIG. 13, in the present embodiment, the route is divided into five route segments 1 to 5.

Subsequently, the general-purpose scenario is assigned to each route segment. As shown in FIG. 13, in the present embodiment, the general-purpose scenario 1 is assigned to the route segment 1. The general-purpose scenario 2 is assigned to the route segment 2. The general-purpose scenario 1 is assigned to the route segment 3. The general-purpose scenario 2 is assigned to the route segment 4.

Here, as for the route segment 5, neither general-purpose scenario 1 nor general-purpose scenario 2 can be assigned to the route segment 5. Therefore, a new third general-purpose scenario (a general-purpose scenario 3) is generated, and is assigned to the route segment 5. The general-purpose scenario 3 is a scenario in which the autonomous vehicle travels straight in the left lane and stops on a road shoulder. At this time, in the same manner as the other general-purpose safety rules, a general-purpose safety rule (a general-purpose safety rule 3) corresponding to the general-purpose scenario 3 is also generated.

The general-purpose safety rule 3 corresponding to the general-purpose scenario 3 is generated as follows. In the general-purpose scenario 3, in a situation in which a plurality of vehicles are travelling on a road having a plurality of lanes, a safety condition is that the autonomous vehicle SV maintains safe distances from other vehicles POVs, and at the same time, a postcondition is that the autonomous vehicle SV travels straight in the left lane and stops at the target position.

In order to achieve the above safety condition and postcondition in the general-purpose scenario 3, the goal-aware RSS divides the scenario in which the postcondition that the autonomous vehicle travels straight in the left lane and stops at the target position is set, into subgoals 31 and 32. The subgoal 31 is to travel in the left lane. The subgoal 32 is to slow down as the autonomous vehicle approaches the target position and to stop at the target position.

By achieving these subgoals 31 and 32 in order, the postcondition of the general-purpose scenario 3 can be achieved. Further, if the control strategy for achieving each of the subgoals 31 and 32 can be executed while constantly satisfying the safety condition, the postcondition can be achieved while satisfying the safety condition.

Next, the general-purpose safety rules corresponding to the general-purpose scenarios assigned to the respective route segments are connected according to an order of the route segments. In the present embodiment, the general-purpose safety rules are connected in an order of the general-purpose safety rule 1, the general-purpose safety rule 2, the general-purpose safety rule 1, the general-purpose safety rule 2, and the general-purpose safety rule 3, then an overall safety rule is generated.

Subsequently, the connectivity is confirmed at the connecting points of the general-purpose safety rules in the overall safety rule. In the confirmation of the connectivity, first, the preconditions and the postconditions of the general-purpose scenarios assigned based on the parameters that are determined by the respective route segments are obtained. Next, in order to connect the route segments, it is logically proven that the postcondition of the preceding general-purpose scenario satisfies the precondition of the following general-purpose scenario.

In the present embodiment, the following connectivity between the precondition and the postcondition is confirmed. The precondition of the route segment 1 (the general-purpose scenario 1) is that the autonomous vehicle starts moving from the starting position and travels in the left lane. The postcondition of the route segment 1 (the general-purpose scenario 1) is that the autonomous vehicle temporarily stops in the right lane before the intersection.

The precondition of the route segment 2 (the general-purpose scenario 2) is that the autonomous vehicle starts moving from the right lane before the intersection. The postcondition of the route segment 2 (the general-purpose scenario 2) is that the autonomous vehicle travels in the left lane after turning right and complies with a legal speed limit.

The precondition of the route segment 3 (the general-purpose scenario 1) is that the autonomous vehicle travels in the left lane. The postcondition of the route segment 3 (the general-purpose scenario 1) is that the autonomous vehicle stops in the right lane before the intersection.

The precondition of the route segment 4 (the general-purpose scenario 2) is that the autonomous vehicle starts moving from the right lane before the intersection. The postcondition of the route segment 4 (the general-purpose scenario 2) is that the autonomous vehicle travels in the left lane after turning right.

The precondition of the route segment 5 (the general-purpose scenario 3) is that the autonomous vehicle travels in the left lane. The postcondition of the route segment 5 (the general-purpose scenario 3) is that the autonomous vehicle stops at the target position.

It is obvious that the postcondition of the route segment 1 logically satisfies the precondition of the route segment 2. It is obvious that the postcondition of the route segment 3 logically satisfies the precondition of the route segment 4. It is obvious that the postcondition of the route segment 4 logically satisfies the precondition of the route segment 5.

Although the precondition of the route segment 3 includes complying with the legal speed limit, the precondition of the route segment 3 is not obvious from the postcondition of the route segment 2. However, based on common sense, there is a high probability of complying with the legal speed limit. Since the postcondition of the general-purpose scenario is defined so as to be socially acceptable, in many cases, the connectivity between the precondition and the postcondition is established. It is noted that a travel speed is derived so as to safely temporarily stop at the end of the route segment 3, as the precondition of the safety rule by the goal-aware RSS.

In the overall safety rule according to the present embodiment, the general-purpose safety rule whose safety is guaranteed by the goal-aware RSS is applied to each route segment, and also the connectivity of the general-purpose safety rule between the route segments is logically proved. Therefore, according to the overall safety rule according to the present embodiment, it is possible to guarantee that the autonomous vehicle SV can safely travel from the starting position Pos₁ to the target position Pos₂.

### Effect of Embodiment

The safety rule generation device according to the present embodiment assigns the pre-defined driving scenario to each of the route segments obtained by dividing the travel route from the starting position to the target position, and generates the safety rule of the entire route by connecting the safety rules for safely travelling in each driving scenario. Therefore, according to the safety rule generation device according to the present embodiment, it is possible to generate the safety rule for safely travelling from the starting position to the target position.

The safety rule generation device according to the present embodiment sets the parameter of the driving scenario so as to correspond to the route segment. With this setting, it is possible to assign the same general-purpose scenario to a plurality of route segments that execute the same type of driving operation. Therefore, according to the safety rule generation device according to the present embodiment, the safety rule can be generated efficiently even if the route is complicated.

The safety rule generation device according to the present embodiment confirms the connectivity of the safety rule of the entire route. In particular, the safety rule generation device according to the present embodiment logically proves that the postcondition of the preceding general-purpose scenario satisfies the precondition of the following general-purpose scenario. Therefore, according to the safety rule generation device according to the present embodiment, it is possible to logically guarantee that the entire route is safely completed.

The moving body according to the present embodiment stores the travel route from the starting position to the target position and the safety rule of the entire route generated by the safety rule generation device, and executes the driving operation so as to travel on the route according to the safety rule. Therefore, according to the moving body according to the present embodiment, it is possible to safely travel from the starting position to the target position.

The autonomous driving system according to the present embodiment includes the safety rule generation device and the moving body. The safety rule generation device generates the safety rule for safely travelling from the starting position to the target position. The moving body executes the driving operation so as to travel from the starting position to the target position according to the safety rule generated by the safety rule generation device. Therefore, according to the autonomous driving system according to the present embodiment, it is possible to safely move the moving body from the starting position to the target position.

### Supplementary Description

Each function described in the above embodiment can be realized by one or a plurality of processing circuits. It is noted that the “processing circuit” in the present application includes a processor programmed to execute each function by software, such as a processor mounted by an electronic circuit, an ASIC (Application Specific Integrated Circuit) designed to execute each function described above, a DSP (Digital Signal Processor), an FPGA (Field Programmable Gate Array), conventional circuit modules, etc.

What is claimed is:

1. A safety rule generation device comprising:
a memory configured to store a plurality of general-purpose scenarios for an autonomously-operable moving body to execute a predetermined driving operation, and a plurality of general-purpose safety rules previously calculated so as to complete the general-purpose scenarios while satisfying a predetermined safety condition; and
a processor coupled to the memory and configured to:
receive an input of route information in which a route of travel from a starting position to a target position is divided into a plurality of route segments;
assign the general-purpose scenarios to the respective route segments; and
generate an overall safety rule in which the general-purpose safety rules corresponding to the general-purpose scenarios are connected according to an order of the route segments.

2. The safety rule generation device as claimed in claim 1, wherein
in the general-purpose scenario, subscenarios, in each of which a control strategy and a goal are associated, are linked, and
in the general-purpose safety rule, a precondition calculated so as to execute the control strategy while achieving the goal for each subscenario, and the control strategy, are combined for each subscenario.

3. The safety rule generation device as claimed in claim 2, wherein
the goal includes the safety condition and a postcondition, and
the precondition is calculated so as to satisfy the postcondition by executing the control strategy while satisfying the safety condition.

4. The safety rule generation device as claimed in claim 3, wherein
the precondition is calculated so as to satisfy a precondition of a following subscenario by executing the control strategy while satisfying the safety condition.

5. The safety rule generation device as claimed in claim 4, wherein
preconditions are sequentially calculated by tracing back a link of the subscenarios.

6. The safety rule generation device as claimed in claim 1, wherein
the general-purpose scenario includes one or more parameters, and
the processor is further configured to set the one or more parameters so that the general-purpose scenario corresponds to the route segment.

7. The safety rule generation device as claimed in claim 6, wherein
the processor is further configured to confirm connectivity of the general-purpose safety rules in the overall safety rule.

8. The safety rule generation device as claimed in claim 7, wherein
the processor is further configured to confirm the connectivity by proving that at a connecting point of the general-purpose safety rules in the overall safety rule, a postcondition of a preceding general-purpose scenario satisfies a precondition of a following general-purpose scenario.

9. The safety rule generation device as claimed in claim 8, wherein
the processor is further configured to generate a safety rule in which the postcondition of the general-purpose scenario corresponding to the preceding general-purpose safety rule is strengthened, at a connecting point where the connectivity cannot be confirmed.

10. The safety rule generation device as claimed in claim 8, wherein
the processor is further configured to generate a safety rule in which the precondition of the general-purpose scenario corresponding to the following general-purpose safety rule is relaxed, at a connecting point where the connectivity cannot be confirmed.

11. A moving body comprising:
a memory configured to store route information, the route information including a route of travel from a starting position to a target position and a safety rule for travelling on the route while satisfying a predetermined safety condition; and
a processor coupled to the memory and configured to execute a driving operation so as to travel on the route according to the safety rule,
wherein the safety rule is generated by:
dividing the route into a plurality of route segments;
assigning general-purpose scenarios for the moving body capable of autonomously operating to execute a predetermined driving operation, to the respective route segments; and
connecting general-purpose safety rules previously calculated so as to complete the general-purpose scenarios while satisfying the predetermined safety condition, according to an order of the route segments.

12. An autonomous driving system comprising:
a safety rule generation device; and
an autonomously-operable moving body,
wherein the safety rule generation device includes:
a first memory configured to store a plurality of general-purpose scenarios for the moving body to execute a predetermined driving operation, and a plurality of general-purpose safety rules previously calculated so as to complete the general-purpose scenarios while satisfying a predetermined safety condition; and
a processor coupled to the first memory and configured to:
receive an input of route information in which a route of travel from a starting position to a target position is divided into a plurality of route segments;
assign the general-purpose scenarios to the respective route segments; and
generate an overall safety rule in which the general-purpose safety rules corresponding to the general-purpose scenarios are connected according to an order of the route segments, and
wherein the moving body includes:
a second memory configured to store route information, the route information including the route and the overall safety rule; and
a processor coupled to the second memory and configured to execute a driving operation so as to travel on the route according to the overall safety rule.

13. A safety rule generation method, executed by a computer, the method comprising:
storing a plurality of general-purpose scenarios for an autonomously-operable moving body to execute a predetermined driving operation, and a plurality of general-purpose safety rules previously calculated so as to complete the general-purpose scenarios while satisfying a predetermined safety condition;
receiving an input of route information in which a route of travel from a starting position to a target position is divided into a plurality of route segments;
assigning the general-purpose scenarios to the respective route segments; and
generating an overall safety rule in which the general-purpose safety rules corresponding to the general-purpose scenarios are connected according to an order of the route segments.

14. A non-transitory computer-readable recording medium having a program embodied therein for causing a computer to perform the method of claim 13.
